(19) United States
(12) Patent Application Publication
(10) Pub. No.: US 2024/0292777 A1
(43) Pub. Date: Sep. 5, 2024

(54) LOW OPERATING TORQUE PNEUMATIC SEED METERING DEVICE

(71) Applicant: Leaf Agrotronic S.R.L., Armstrong (AR)

(72) Inventors: Alejandro Rogelio Clerici, Armstrong (AR); Mauricio Alberto Eguchi, Armstrong (AR); David Eduardo Kelly, Armstrong (AR); Iván Javier Gorostiza, Armstrong (AR); Marco Gastón Baldoni, Armstrong (AR); Juan Victor Mozzicafreddo, Armstrong (AR); Javier Horacio Meléndez, Armstrong (AR)

(21) Appl. No.: 18/593,272

(22) Filed: Mar. 1, 2024

Related U.S. Application Data
(60) Provisional application No. 63/488,322, filed on Mar. 3, 2023.

(51) Int. Cl. A01C 7/04; A01C 5/06; A01C 7/10

(52) U.S. Cl. CPC A01C 7/046; A01C 7/0445; A01C 7/102; A01C 5/064; A01C 5/066

(57) ABSTRACT

A pneumatic metering unit, which operates with vacuum pressure to dispense monograin seeds. Particularly, the pneumatic dispenser subject matter of the invention operates with low applied torque, while maintaining tightness in the vacuum chamber and keeping the working pressure constant, without variations or fluctuations due to the action of the seal, beyond the normal variations, due to the nature of the work, within the operating pressure threshold. In this sense, the reduction of necessary moving parts that could suffer jamming, as well as the implementation of an axial action spring that holds the seal in contact with the dosing plate in a constant way, regardless of the conditions and material characteristics of the seal, stand out.

### CROSS-REFERENCE TO RELATED APPLICATION

This application claims the benefit of priority from U.S. provisional application No. 63/488,322 filed Mar. 3, 2023, the contents of which is incorporated herein by reference.

### TECHNICAL FIELD OF THE INVENTION

The present invention belongs to the field of agricultural machinery for sowing. More precisely, the present invention corresponds to a low operating torque pneumatic seed dosing device, of the type operating with negative pressure, or vacuum, for dosing seeds individually and periodically at regular intervals.

### BACKGROUND OF THE INVENTION

Currently, a wide variety of pneumatic seed metering devices are known to develop the sowing activity. In particular, these metering units are arranged in rows along the frame of a planter which may be comprising various configurations. Generally, seed drills are mainly composed, among other elements, of a general deposit of the material to be sown, means to open sowing furrows, the aforementioned metering devices that dispense the grains in said furrows, means to cover the furrows once the seeds have been placed as the seed drill moves forward towed by the tractor. Eventually and depending on the specific sowing to be carried out, means of storage and dosage of fertilizers can also be provided, either in the form of particulate or liquid material.

With regard to the sowing of crops such as corn, sorghum, soybean, sunflower, among others, it is essential to use precision sowing means that allow maximizing the use of the crop land and the potential of the seeds by dosing the seeds at regular intervals. In this sense, pneumatic dosers are the best known solution due to the great precision they achieve when dispensing the grains on the field, with a high working speed and allowing to arrange them in several rows in the same seeder, which enables to cover a large portion of land in a single pass.

These pneumatic metering units have been studied and perfected, marking a great evolution in modern sowing tasks, allowing to optimize more and more the cultivation campaigns.

Among the many different configurations that pneumatic dispensers can adopt, they mainly are comprising a chamber with at least one inlet opening wherein the material to be dispensed enters from the storage of the seeder; and at least one outlet opening, wherein the grains are directed to the soil. Inside the chamber there is usually at least one rotating plate with a series of hollows or alveoli, located parallel to the peripheral contour of the chamber, wherein the grains are placed individually, as the plate rotates as the seeding train advances. The dosing plate is linked to a drive shaft that rotates it and performs the function of establishing regular seed dosing intervals. The seeding frequency is determined by its rotation speed. As it rotates, the plate drives the seeds towards the seed distributor, which directs the grains into the soil, depositing them one by one periodically along a furrow previously opened by the furrow openers of the seeder.

Eventually, the dosers may be comprising a wide variety of other components that make up the function, such as, for example, singulating blades or flushers that prevent more than one grain from lodging in the same cavity of the dosing plate; uncoring means such as, for example, rollers with protuberances that release the cavities in case the seed is not ejected through the dispensing mouth; agitators to facilitate the movement of the grains in the seed chamber; among others.

Mainly, there are two types of pneumatic dosers, classified according to their operation, being some of them of positive pressure, wherein by means of the assistance of compressed air the seeds are propelled along the aforementioned path; and others, like the subject matter of the present invention, which operate at negative pressure wherein, by means of a suction turbine, a vacuum is exerted that attracts the grains against the dosing plate and then they are driven towards the ground, as explained.

For the correct dispensing of the material to be sown and to be able to guarantee the precision in the cultivation, it is necessary to ensure the tightness of the dosing chamber, which allows a uniform and complete distribution of the grains. While operation with partial sealing or fluctuations is possible, it is an unfavorable condition that requires increased pneumatic power to compensate for deficiencies. The optimum operating condition is achieved with complete chamber tightness that minimizes the power demand of the equipment.

In this regard, a wide variety of solutions are currently known that aim to maintain the tightness of the metering chamber, comprising a variety of seals, gaskets and closures of different types and characteristics.

Flexible seals are often used, generally made of plastic or elastomer materials, which are pressed against the dosing plate and deform on its surface due to the vacuum generated. The result is an increase in the normal force of the seal against the plate causing a high frictional resistance to movement, which translates into a higher torque applied to rotate the seed discs.

The torque used to operate the metering mechanism is a fundamental and limiting parameter in the design of seed dispensing equipment because it determines the characteristics of the transmission or driving means used to produce the movement.

In this sense, there is a recurring problem of having a pneumatic dosing device that maintains a tightness in the chamber that does not produce fluctuations in the working pressure and, at the same time, operates with a reduced torque value so as not to increase the energy demand of the driving means.

An alternative that reduces the torque applied in pneumatic dispensers is the use of rigid seals. This type of seals, by not deforming due to the effect of negative pressure and not increasing the normal force against the plate, generate less friction and less resistance to plate movement. However, they present the difficulty of remaining static with respect to rotation.

To avoid unwanted rotation, means of attachment to the seal bracket are used, generally comprising insertion guides or bolts, among other variants.

An example of this is the dispenser described in U.S. Pat. No. 10,334,773B2, which addresses the problem of reducing friction and thus the torque applied in the operation of the dispenser, by means of a rigid seal that is placed mounted on guides formed in the housing that makes up the dispenser chamber. This configuration has the practical disadvantage that, due to the nature of the task for which the equipment is intended, it is frequently exposed to vibrations and dirt, such as dirt, mud and other particles that, with time and use, begin to lodge in the seal fastening channels. The progressive fouling of the guides that hold the seal in position causes the seal to move from its original location and, in addition, the dirt and mud accumulated in these sectors begins to rub against the moving parts of the equipment, generating an increase in the torque required. Likewise, to guarantee the tightness of the chamber, helical springs are often used to press the seal against the plate and thus ensure support. As explained above, the use of this type of springs presents the main difficulty of clogging and jamming due to the fouling to which the dosing equipment is exposed. It is very common the entry of soil removed by the passage of the machines, which with the humidity becomes mud and clogs the moving parts of the mechanisms producing a deficiency in the tightness of the chamber which finally translates into a decrease in the effectiveness of the seed dosage.

Another variant of solution to the problem of excessive torque applied in pneumatic dispensers is raised in the European patent EP2810546B1. In said document, a pneumatic dispenser is described which, among other things, is comprising sealing means for ensuring the tightness of the vacuum chamber and that, principally, such sealing means comprise an elastic seal and a friction insert.

This device combines the action of rigid and flexible seals. On the one hand, the elastic seal, which can adopt different configurations such as, for example, being hollow or solid core, or containing lips; which provides the benefits of the tightness of a flexible seal and, additionally, a friction insert is used, of greater rigidity and lower friction coefficient, as a sacrificial element to withstand attrition due to friction with the plate and to reduce the applied torque.

It is described in the paper that the flexible joint exerts a force within the range of 10 N to 100 N on the friction insert, pressing it against the metering plate.

The main disadvantage of the referenced development is that the effectiveness of the seal and the tightness of the vacuum chamber depend on the preservation and durability of the characteristics of the flexible gasket, because, as the flexible gasket degrades progressively, the initial properties and the compression capacity of the friction insert against the dosing plate are lost, which, as mentioned above, results in a deficiency of the tightness of the dosing chamber.

In addition to the above, the progressive loss of thickness of the friction insert due to wear caused by attrition against the dosing plate must be considered. This fact, in combination with the previous one, leads to a progressive decrease in the airtight capacity of the chamber.

Likewise, the moving parts are comprising this type of seal present the disadvantages mentioned above, referred to the fouling and accumulation of particles or mud that progressively diminish the offset capacity of these elements and cause fluctuations in the sealing. Therefore, although the present device addresses the problem of the high friction generated between the seals of the chamber and the dosing plate, the mechanism is not robust as a set, generating a deficit in the durability and preservation of the operating parameters over time, demanding more frequent and complex maintenance campaigns.

On the other hand, antecedent AR104254A4 was identified, which is aimed at a pneumatic distributor of single-seeds that seeks to address the problem of limiting the operating torque in the dispensing of material.

Herein, the implementation of rigid seals is studied to apply a limited stress that does not generate excessive friction on the seed plate. However, it has the disadvantage, on the one hand, of needing to fix the seeding disc between two plates to give it rigidity, which makes the design more complex. In addition, another significant disadvantage consists of means for exerting pressure of the seals against the plate, since the same is comprising the use of elastic springs, which have the disadvantages described above. The effectiveness of these springs depends on the preservation and durability of their elastic characteristics since, as they degrade, there is a decrease in the force that presses the seals against the plate, which translates into leakage defects over time.

### SUMMARY OF THE INVENTION

It is, therefore, a subject matter of the present invention to provide a pneumatic seed metering device that overcomes the noted drawbacks of the prior art by means of a robust design that allows to ensure complete tightness in the vacuum chamber and to limit friction against the metering plate, thus allowing to operate with reduced torque.

As will be detailed below, the present invention is comprising a pneumatic dispenser, which operates with vacuum pressure to dispense seeds such as corn, sorghum, soybeans, sunflower, and the like. Particularly, the pneumatic dispenser subject matter of the invention presents the advantages over the previous technique of operating with low applied torque, while maintaining the tightness in the vacuum chamber and keeping the working pressure constant, without variations or fluctuations due to the action of the seal, beyond the normal variations, due to the nature of the work, within the operating pressure threshold. In this sense, the reduction of moving parts that could suffer jamming is highlighted, as well as the implementation of an innovative axial action spring that keeps the seal in constant contact with the dosing plate, regardless of the conditions and material characteristics of said seal. Thus, the proposed configuration is superior to the prior art since the effectiveness of the seal is not affected by attrition or degradation of the materials that make it up, since the compression against the metering plate does not depend on the stiffness or mechanical stress of it, but, on the contrary, the action of the orthoplane spring allows maintaining the contact of the seal against the plate, as the seal wears.

### BRIEF DESCRIPTION OF THE FIGURES

FIG. 1 illustrates a standard seeding train with a pneumatic seed metering unit according to a variant embodiment of the present invention, mounted.

FIG. 2 illustrates an open view of a pneumatic seed metering device according to a variant embodiment of the present invention.

FIG. 3a is a view of one half of a pneumatic seed metering unit, according to an embodiment variant, corresponding to the vacuum chamber.

FIG. 3b is a view of one half of a pneumatic seed metering unit, according to an embodiment variant, corresponding to the seed chamber.

FIG. 4 corresponds to another view of one half of a pneumatic seed metering unit, according to a variant of embodiment, corresponding to the vacuum chamber, wherein the drive disk was removed from the metering plate.

FIG. 5 is a view of the cut A-A shown in FIG. 4.

FIG. 6a is a perspective detail of an orthoplane spring and rigid seal set, according to a variant embodiment of the present invention.

FIG. 6b is a detail from a top view of an orthoplane spring and rigid seal set, according to a variant embodiment of the present invention.

FIG. 7 corresponds to another view of one half of a pneumatic seed metering unit, according to a variant of embodiment, corresponding to the vacuum chamber, wherein the orthoplane spring and rigid seal set was removed.

FIG. 8 is a view of the cut A-A shown in FIG. 7.

FIG. 9 is a detail from a top view of a flexible bellows in accordance with a variant embodiment of the present invention.

FIG. 10 is a view of one half of a pneumatic seed metering unit, according to an embodiment variant, corresponding to the vacuum chamber.

FIG. 11 is a preliminary design of an orthoplane spring configuration used in the embodiment tests of the present invention.

FIG. 12 is a modified design of an orthoplane spring configuration refined by iterative embodiment tests.

### DETAILED DESCRIPTION OF THE INVENTION

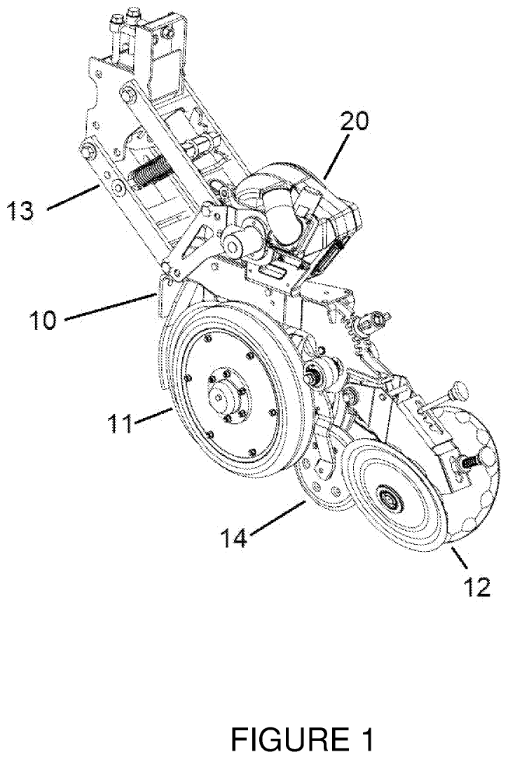

As can be seen in the figures shown above, the present invention has as its subject matter a pneumatic dosing device for ‘single-seed’ type seeds (such as corn, sorghum, soybean, sunflower, among others). Commonly, according to FIG. 1, the pneumatic metering units are mounted on a set generally referred to as a seeding train which, among other elements, mainly is comprising a frame or chassis (10) which is subject, in turn, to the body of the seeder. To this frame or chassis (10) are mounted at least one disc or cutting blade (not illustrated) in charge of plowing the ground as the seeder advances; at least one set of furrow opening wheels (11) that open the channel wherein the material is going to be dispensed; at least one set of plugging wheels (12) that close the furrow once the seed or grain sown has been deposited. Also, on the same frame or chassis (10) is placed the pneumatic dispenser (20), in charge of dispensing the seeds at regular and periodic intervals. Other components of the frame may include suspension assemblies (13) of different configurations; “grain treading” elements (14) that press the seeds against the bottom of the furrow, which may take the form of tabs, wheels, forks, among others. The variants and arrangements that can be adopted by the sowing trains are wide and diverse, depending on the specific task and sowing campaign for which they are intended.

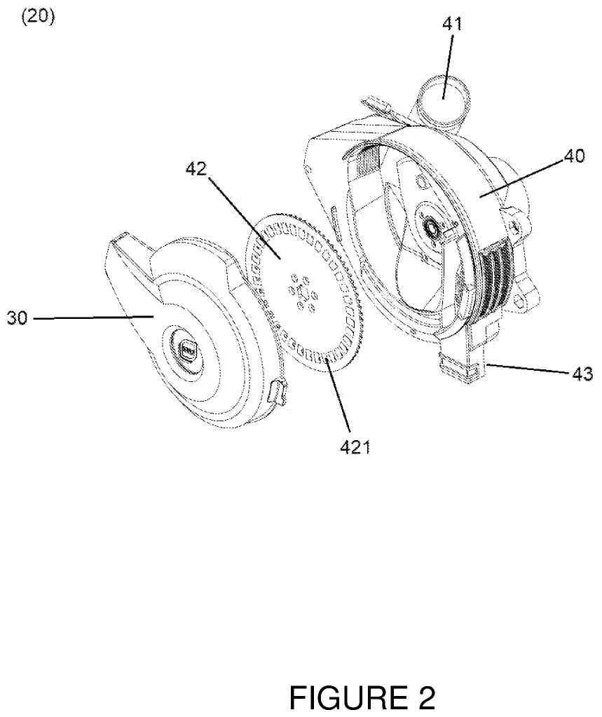

In FIG. 2, it can be observed a pneumatic dosing device (20) single grain, according to a variant of embodiment of the present invention. In its external appearance, it can be seen that it is mainly made up of two outer shells (30; 40) that define two halves of the device. In general terms, the common operation of these dispensers is comprising to receive the seeds to be dispensed from a tank, which enter the dispenser (20) and, by means of a dosing plate (42), generally circular, with a series of perforations or alveoli (421), arranged parallel to the perimeter of the same, the grains are driven individually towards the outlet (43), to end up in the soil to be sown.

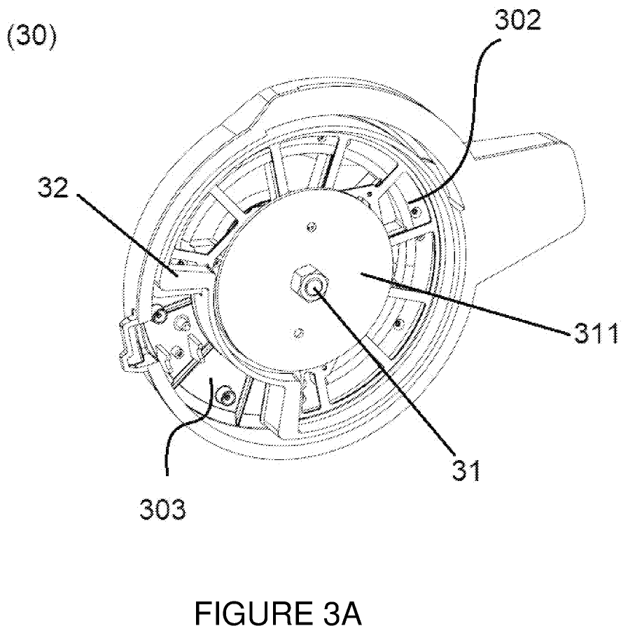

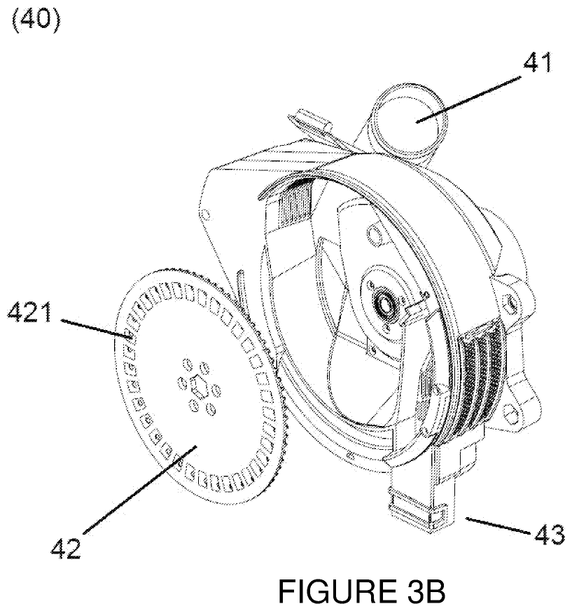

For clarity of the present description, said halves will be defined as vacuum chamber (30) and seed chamber (40), which are detailed in FIGS. 3a and 3b respectively. The seed chamber (40) receives the grains to be dispensed from a feed nozzle (41) connected to a general hopper or grain hopper located upstream in the seeder body. The seeds are lodged in a gap provided in the seed chamber (40) and by the action of the vacuum pressure they occupy one by one the cavities (421) of the dosing plate (42). Preferably, but not exclusively, the pneumatic dispensers are comprising singulating means, which may take the form of screeding blades, combs, brushes, among others; which are responsible for ensuring that each alveolus (421) of the plate (42) is occupied by a single seed. As the seeder advances, the metering plate (42) rotates and drives the grains from the seed intake to the outlet (43), from wherein the grains fall by gravity, and driven by the tangential speed with which they are released from the plate, into the furrow opened in the ground for sowing.

For its part, the vacuum chamber (30), as shown in FIG. 3a, is comprising the means and components relevant to the pneumatic circuit of the system. The negative working pressure acting on the seed chamber (40) is provided by means of the same, for the capture of the grains in the dosing plate (42). According to a variant embodiment of the present invention, the vacuum chamber (30) is connected to a vacuum source, which provides the negative operating pressure. However, this design variant is not limiting to the invention, and the vacuum source may be connected by means of hoses directly to the interior of the chamber (30), as is the case in most ordinary dispensers of the style.

In the center of the vacuum chamber (30) you can see the shaft (31) in charge of transmitting the rotation, from the control, to the drive disk (311), on which the dosing plate (42) is coupled. The shaft (31) applies a torque to the drive disk (311), generated by a drive source such as an independent motor located outside the dispenser. As explained above, the applied torque is a limiting parameter in the operation of seeding equipment, since it is directly related to the energy consumption of the machinery and also to the attrition caused by stress on the components of the device.

Between the driving disc (311) and the dosing plate (42) there are fastening means that produce the solidary movement between them.

Additionally, two zones can be identified in the vacuum chamber (30). A vacuum zone (302), of greater proportion, bounded by the contour of a seal (32), which will be discussed in detail below. The other zone (303), of atmospheric pressure, not reached by the vacuum effect, of smaller proportion, is delimited by the outer perimeter of the seal (32), in a sector wherein a cutout is arranged for this purpose, and the chamber housing itself (30).

When an alveolus (421) of the seed plate (42) rotates within the portion comprised by the vacuum zone (302), negative pressure keeps the grains positioned within said alveolus (421). Once said alveolus (421) passes into the atmospheric pressure zone (303), the grain is released from the alveolus (421) and falls by gravity through the dispensing nozzle (43). Eventually, to prevent the grains from clogging in the alveoli (421) and not dislodging from the plate (42), unclogging means are provided which expel the grains, or other obstructions, such as dirt, from the alveoli (421). These unblocking means can adopt various shapes and configurations, the most traditional being those in the form of wheels or rollers with protrusions.

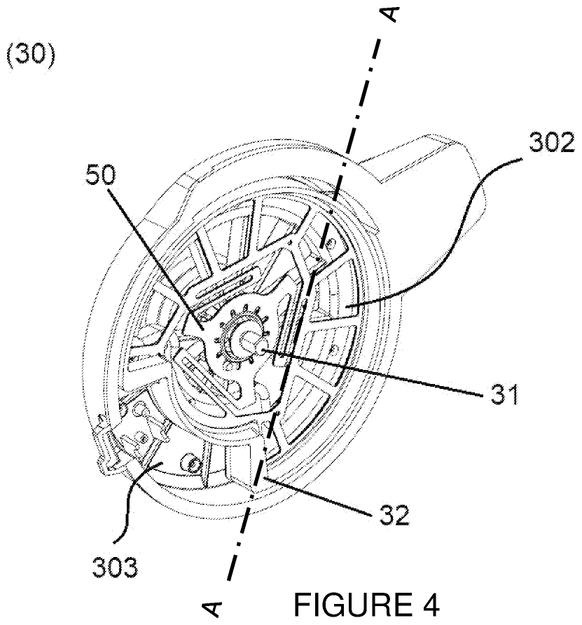

To ensure the correct lodging of the seeds in the cavities (421) of the dosing plate (42), it is necessary to be able to sustain a negative operating pressure above a minimum necessary value, without fluctuations or variations, which could cause the seeds not to be placed in the cavities (421), or seeds already placed to fall out of place, resulting in an interruption of the periodic dosing of seeds to the soil. In this sense, ensuring a constant vacuum pressure is crucial for the optimum performance of the sowing campaign, since this way it is possible to guarantee the correct placement of grains in the furrows, at the desired intervals and density. For this purpose, and according to in FIG. 4, a rigid seal (32) is arranged in the vacuum chamber which, in operation, comes into contact with the seed plate (42) to form a vacuum-tight zone (302). The seal (32) has a low coefficient of friction, which produces a low frictional resistance to the rotary motion of the plate (42), resulting in a lower requirement of the torque applied to rotate the mechanism. Thus, the rigid seal (32) may be made of a polymer, acetal resin, or other material having the characteristics described above. In some embodiments, the rigid seal (32) may be compound of a first structural material in its body, such as metal, polymers, acetal resin or other plastics; and have a second material in the contact area with the plate (42), such as acetal resin or other polymers of low coefficient of friction and high attrition resistance; so as to be able to combine the different structural rigidity properties of one material with the low friction and sealing capability characteristics of another. According to some variants of embodiment, the sections of different materials may be linked together by gluing, riveting, interlocking, co-injection of both materials, among others.

Particularly, the rigid seal (32), presents a semi-circular shape is comprising a larger perimeter (322), which accompanies the contour of the vacuum chamber housing (30) and completely covers the line of alveoli (421) of the seed plate (42); interrupted by two radial sections (321), which extend inwardly; and a smaller perimeter (323), which connects said radial sections (321) and closes the total contour of the seal (32).

As advanced above, the zone delimited inside the rigid seal (32), is the vacuum zone (302), i.e. the portion of the chamber (30) which is under the influence of the vacuum source, which generates the negative working pressure. Consequently, the area defined by the minor perimeter (323), the radial sections (321) and the chamber housing (30) is outside the suction effects and is therefore at normal atmospheric pressure. This zone is then defined as the atmospheric pressure zone (303).

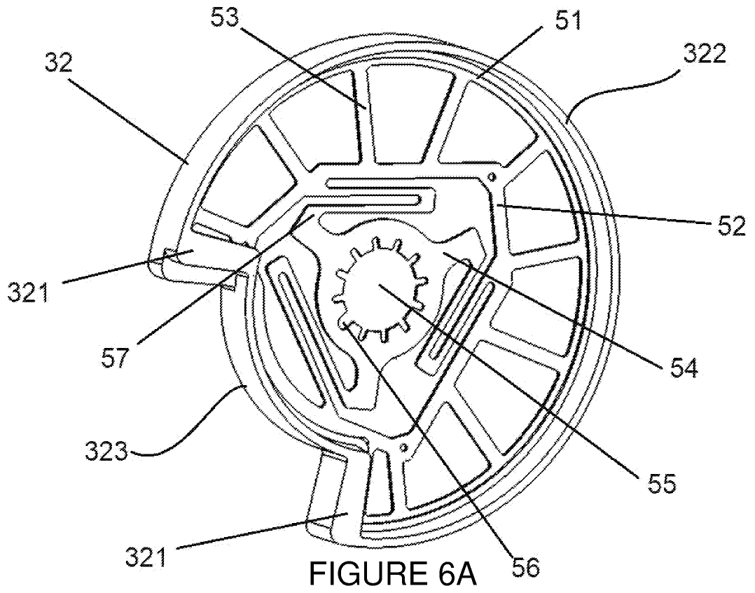

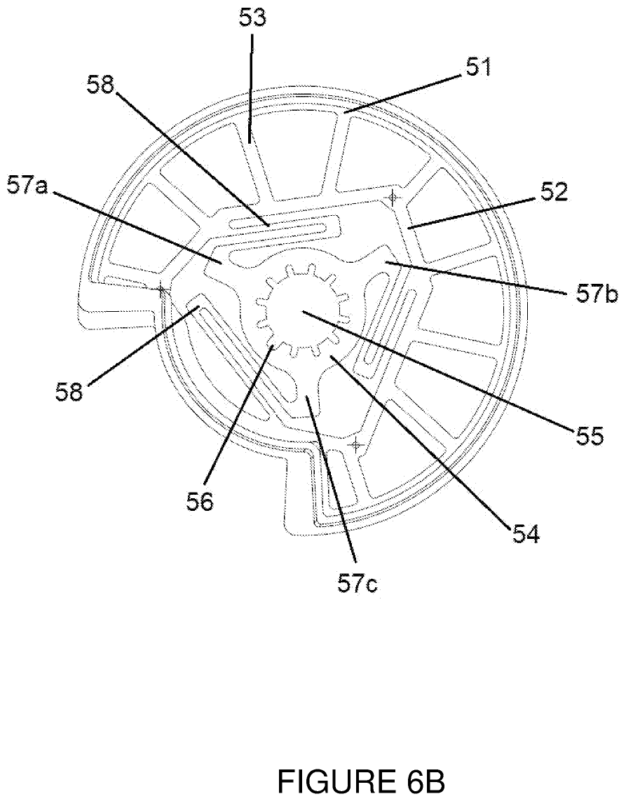

When, in its direction of rotation, an alveolus (421) of the metering plate (42) which is occupied by a seed passes through the first radial segment (321), said alveolus is no longer under the influence of the vacuum pressure and, therefore, the grain no longer remains adhered to the plate (42), so that it falls by gravity towards the dispensing nozzle (43), which directs it towards the ground. Opportunely, in the atmospheric pressure zone (303) an unclogging mechanism can be found, which ensures that no grains are improperly jammed in the alveoli (421) of the plate (42). In order to maintain and ensure the contact of the rigid seal (32) against the seed plate (42), inside said seal (32), and linked to it, an orthoplane spring (50) of axial action is arranged. This spring (50), as shown in FIG. 4 and, in greater detail, in FIGS. 6A and 6B, has an outer contour (51) that imitates and accompanies the silhouette of the rigid seal (32); an inner perimeter (52), linked to the outer contour (51) by means of a plurality of spokes (53) and; a center (54), comprising a central bore (55), wherein the drive shaft (31) passes.

Cut into the central bore (55), there is at least one notch (56). Said at least one notch (56) engages some bolts or clamping means, which will be detailed later, and which perform the function of restricting the angular movement of the spring (50) and, therefore, of the rigid seal (32). This is a fundamental function since it is essential to prevent the seal (32) from rotating or moving angularly from its initial position, which would alter the position of the radial sections (321), modifying the location of the vacuum (302) and atmospheric pressure (303) zones, resulting in faulty dosing.

Following said center (54), a plurality of action arms (57) are extended in radial direction, in charge of performing the axial effort to press the seal (32) against the dosing plate (42), while also providing angular rigidity. The action arms (57) link the center (54), which remains fixed, both axially and angularly, with the inner perimeter (52) which distributes and transmits, by means of the plurality of spokes (53), the compressive stress to the outer contour (51) and thus to the rigid seal (32). The principle of operation of the action arms (57) is governed by the action of fork-shaped levers (58), which deform orthogonally, leaving the coplanar position of rest when subjected to a stress.

It should be noted that, because the geometry of the rigid seal (32) is not symmetrical in the extension of its contour, the action arms (57) are configured to perform a differential stress, in order to maintain a constant and uniform pressure of the seal (32) against the metering plate (42). Likewise, this feature of differentiated action arms (57), allows to dynamically compensate possible inclinations of the surface of the plate (42) due to deviations with respect to the perpendicular of the shaft (31).

Based on a variant of embodiment, illustrated in FIGS. 6A and 6B; the orthoplane spring (50) is comprising three action arms (57A; 57B and 57C), which, in turn, is comprising different lever lengths (58), calibrated to adjust the compression as a function of their distance from the external contour (51), linked to the rigid seal (32).

It can be seen from the detail that the action arm (57C) has a lever length (58) greater than that of the arm (57A) and, even more, than that of the arm (57B). Because the action arm (57C) is closer to the outer contour (51), since it is located in the section wherein the rigid seal (32) has the cutout to define the atmospheric pressure zone (303), the pressure to be exerted is less than that of its peers, so that a greater lever length (58) offers greater elasticity to the axial movement. Conversely, the action arm (57B) is located at a greater radial distance from the outer contour (51), compared to the arm (57C), and therefore has a shorter lever length (58), which gives it greater rigidity and resistance to axial movement, i.e., it exerts a greater compressive stress. For its part, the action arm (57B) behaves analogously to its peers, with an intermediate lever length (58), which corresponds to the compressive stress applied to the rigid seal (32) against the metering plate (42).

The geometry and arrangement, as well as the number, of the action arms (57) of the orthoplane spring (50) may vary according to the configuration and characteristics of the dispenser wherein they are mounted.

Among the materials suitable for the manufacture of this spring are spring steel, polymers with or without fiberglass load, or other material with mechanical characteristics such as to avoid distension or relaxation over time, so that the force exerted does not vary. Also, the spring must be made of a material that is resistant to the operating conditions of the machinery, such as temperature, humidity or chemical attack produced by fertilizers. A further necessary condition of the spring making material (50) is that it must deform only elastically, and within the intended operating parameters. Likewise, the ways of manufacturing the same extend, but are not limited to: cutting of sheets, by means of laser pantography or other technique; molding; injection; among others.

According to a variant embodiment of the present invention, the orthoplane spring (50) is made by a packing of overlapping sheets.

According to another embodiment, the orthoplane spring (50) is made in one piece. In certain embodiment variants, the orthoplane spring (50) is linked to the rigid seal (32) by means of interlocking inserts; glued; riveted and/or welded.

In other embodiments, the orthoplane spring (50) and the rigid seal (32) form a single part, formed by molding, unit injection, co-injection of various materials, or combinations thereof.

This spring (50) has many advantages over the coil springs commonly used in the prior art. Firstly, since it is not associated with other moving parts running in guides, there is no clogging due to fouling, which reduces the effectiveness of the operation. Also, according to what was explained, by implementing a single spring (50) it is possible to apply a constant pressure around the entire contour of the rigid seal (32), which adjusts dynamically against variations in the surface of the plate, ensuring at all times a complete seal without fluctuations.

Being linked only to the orthoplane spring (50), the rigid seal is kept floating, thus dispensing with the use of guides to lead to said seal, which, according to what has been commented, suffer obstructions due to fouling which results in a defective operation of the seal and loss of tightness. Similarly, the orthoplane spring (50), while transmitting the differential axial pressure to the rigid seal (32), remains invariant in its angular position, so that, at all times, the vacuum zone (302) remains static and hermetic.

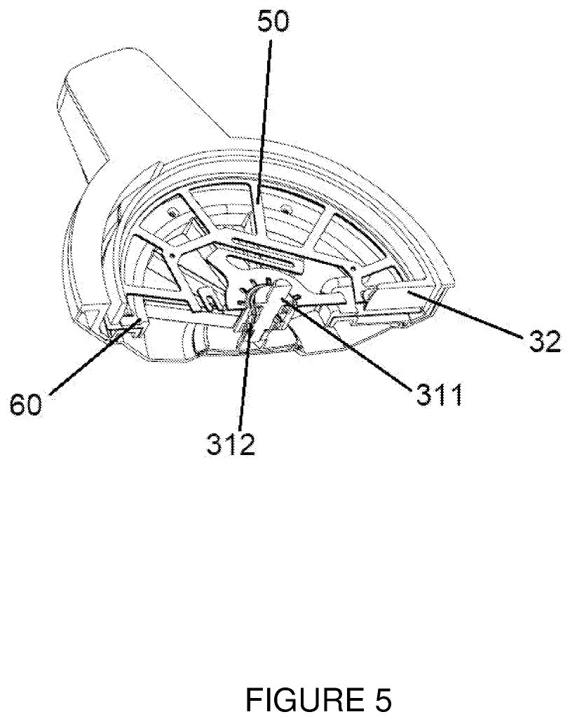

In a variant embodiment, illustrated in the cutaway of FIG. 5, the seat of the orthoplane spring (50) can be clearly seen.

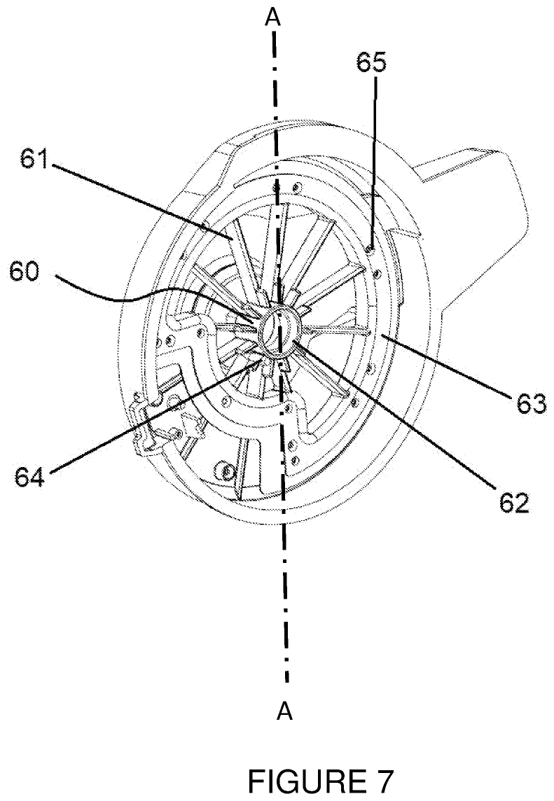

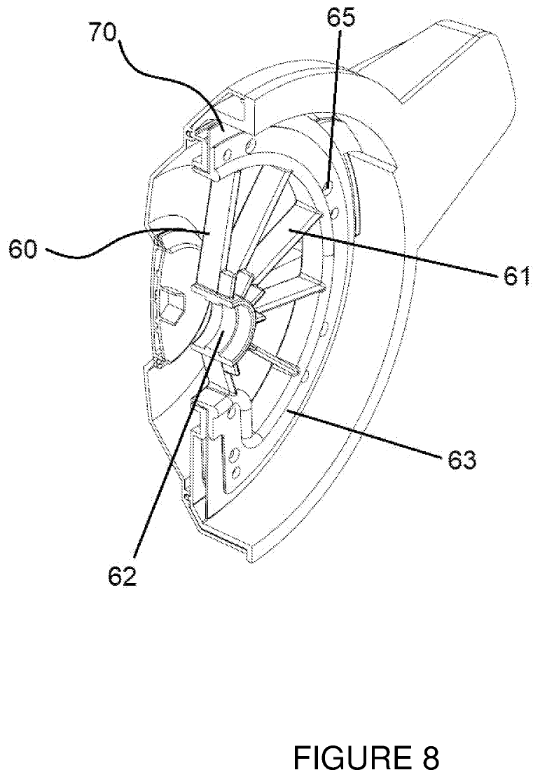

According to the variant of embodiment illustrated in said FIG. 5, and in greater detail in FIGS. 7 and 8, below the orthoplane spring set (50) and rigid seal (32), there is provided a subchassis (60) consisting of a plurality of spokes (61), extending from the center (62) towards the outer contour (63), which imitates and accompanies the silhouette of the rigid seal (32).

The center (62) of the subframe (60) is mainly hollow and houses a hub bearing (312) of the drive shaft (31). Also, at least one protrusion and/or recess (64) is provided at the top of the center (62), which is the complement of the at least one notch (56) openworked in the central bore (55) of the orthoplane spring (50). Said at least one detent (64), is in charge of preventing the angular movement of the orthoplanear spring (50), and keeping it fixed with respect to rotation. In this way, added to the fact that the center (62) of the subframe (60) prevents radial offsets, the only degree of freedom of the orthoplane spring (50) is in the axial direction, through deformation.

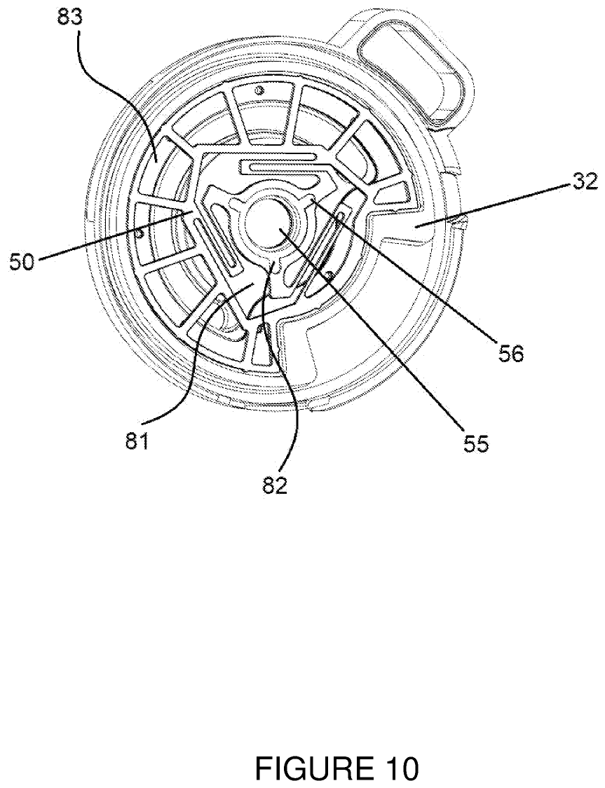

In the realization illustrated in FIGS. 7 and 8, the beams (61) contribute to the robustness and solidity of the whole set, although they are not indispensable as can be seen in another variant of embodiment, shown in FIG. 10.

The outer contour (63) of the subframe (60), has a flange arrangement, which results in the entire subframe (60) operating as a flange that holds, against the vacuum chamber housing (30), an elastic membrane (70).

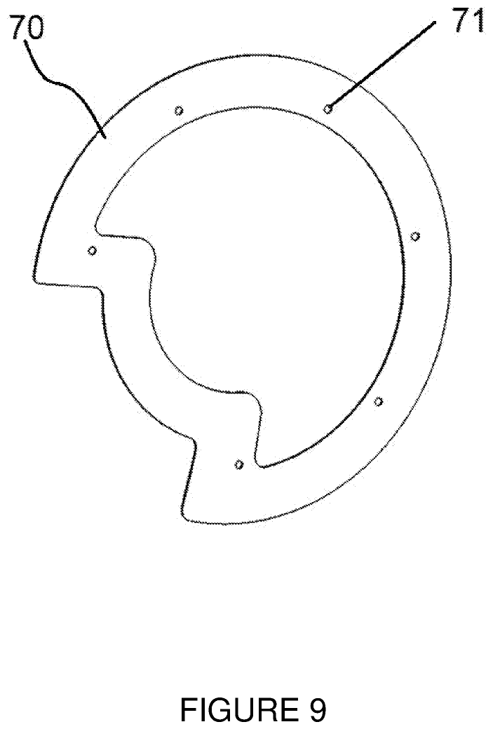

Said elastic membrane (70), illustrated in detail in FIG. 9, has a contour that imitates and accompanies the silhouette of the rigid seal (32). It is essentially flat and has a band width such that it protrudes from the outer contour flange (63) of the subframe (60).

As explained above, the rigid seal (32) is kept floating, linked to the orthoplane spring (50). When the dispenser (20) is in operation, vacuum is exerted within the chamber (30) and the seal (32) is compressed against the dosing plate (42). By the same vacuum effect, the flexible membrane (70) deforms and adheres against the underside of the rigid seal (32) completely closing the vacuum zone (302). The flexible membrane (70) seals the small gap between the rigid seal (32) and the vacuum chamber housing (30) when at rest.

Preferably, the flexible membrane is composed of a material of low stiffness and high elasticity, so as to allow its deformation under the vacuum effects generated in the chamber (30). Preferred materials for making said flexible membrane (70) include, but are not limited to, the following: silicone, NBR or the like.

According to the variant of embodiment illustrated in FIG. 9, along the entire length of the band of the flexible membrane (70), perforations (71) are arranged which coincide, conveniently, with analogous perforations (65) arranged in the flange of the external contour (63) of the subchassis (60), for inserting in them means of attachment between said subchassis (60) and the membrane (70).

According to another variant of embodiment, the bonding between the subframe (60) and the flexible membrane (70) can be by gluing; riveting; bolting; screwing; embedding; among others.

According to another variant embodiment of the present invention, as illustrated in FIG. 10, the orthoplane spring (50) may be located in a seat (81) formed directly in the vacuum chamber housing (30). As can be seen, due to different design features, it is not necessary to have a subframe (60) as in the previous case. The vacuum chamber housing (30) has a seat (81) comprising at least one recess (82), which is the complement of the at least one notch (56) openworked in the central bore (55) of the orthoplane spring (50), to prevent angular movement of the spring (50) and, consequently, of the rigid seal (32). Additionally, in the center of said seat (81), a central bore (85) is provided wherein the hub bearing (312) of the drive shaft (31) is located. In the absence of a subframe (60), a flange (83) supporting the flexible membrane (70), whose function was detailed in previous paragraphs, is provided in this embodiment. Equivalently as explained above, the flexible membrane (70) is comprising, arranged in the band, perforations (71) coinciding, conveniently, with analogous perforations (84) arranged in the flange of the external contour of the flange (83), for inserting therein fastening means between said flange (83) and the flexible membrane (70).

Regardless of the design of the pneumatic dispenser (20) and the embodiment variant used, the flexible membrane (70) is deformed by the action of the vacuum generated inside the chamber (30). Although the flexible membrane (70) naturally comes into contact with the lower area of the rigid seal (32), it does not contribute to the compressive stress of the seal (32) against the metering plate (42). The main component of the compression force of the rigid seal (32) against the dosing plate (42) is given by the action of the orthoplane spring (50), resulting any other contribution, either from the flexible membrane (70) or any other component, negligible.

In some variants of embodiment, the flexible membrane (70) can adopt a geometry different from the flat one, forming then a bellows, being able to contain in its periphery at least one of the following: a lip, a flange, a raised extension, or a combination thereof. Likewise, according to other embodiments, the flexible membrane or bellows (70) may also be comprising snap-in means for coupling to the vacuum chamber housing (30).

### EXAMPLES

For the manufacture and application of the orthoplane spring that exerts the compression force of the rigid seal against the seed plate, a plurality of parameters and geometrical arrangements of its components were analyzed in detail.

In order to ensure that the seal, linked to the spring, applies a homogeneous contact pressure on the plate, so that there is no excessive attrition in specific areas due to excess pressure, or leakage due to contact failures due to lack of pressure, iterative tests were carried out on the following parameters:
Length of action arms.
Width of action arms.
Location of the contact point between the action arms and the periphery.
Spring thickness.
Number of springs used.
Spring material.
Linkage between springs, in cases where there is more than one.

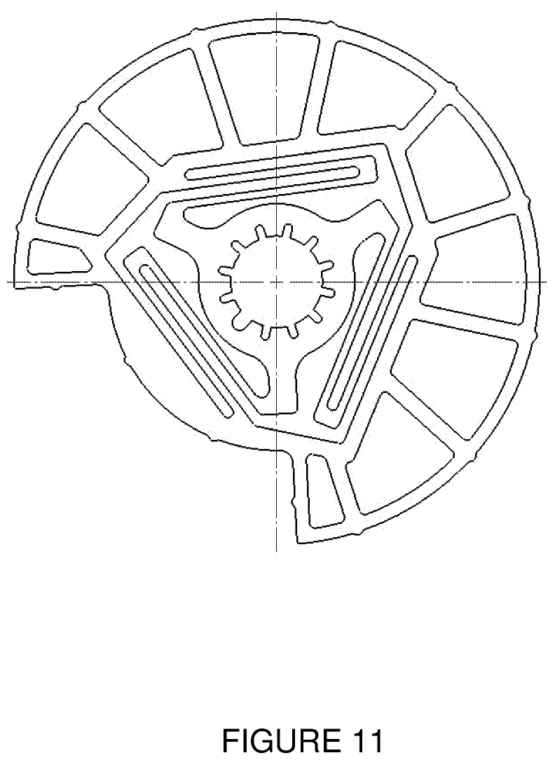

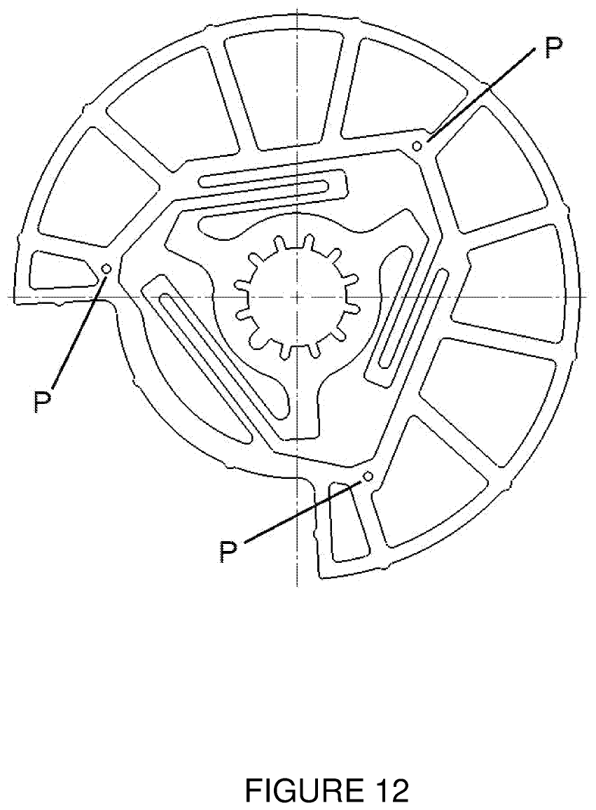

Starting from a preliminary configuration of the spring, illustrated in FIG. 11, effectiveness tests and iterative simulations were carried out, which resulted in several modifications, improving at each stage the spring performance, achieving greater homogeneity in the pressure generated by the seal, while no dragging or relaxation effect is produced when the spring acts with the maximum deformations. The improved orthoplane spring configuration is illustrated in FIG. 12.

### Simulation Results by Finite Element Method (FEM):

Simulations were performed on the springs illustrated in FIGS. 11 and 12, respectively, to analyze the improvement in the homogeneity of the pressure exerted. In the analysis, an offset over the center of the spring was printed, restricting the axial displacement of the outer perimeter.

In the configuration illustrated in FIG. 12, an improvement in pressure homogeneity of 22% over the initial arrangement shown in FIG. 11 was obtained. The force exerted by the spring was also doubled.

### Empirical Measurements:

On certain occasions, it is necessary to use more than one spring to achieve the desired compression force. In this regard, the effect and existence of negative impacts on the homogeneity of the force through the use of stacked spring packings was analyzed. The increase in stiffness achieved by using more than one spring was also studied.

In those tests wherein anchors were used to attach to the plurality of springs, the location of the anchors was determined based on the results of the FEM analysis. In particular, three main cases were studied:
Single spring.
Three stacked springs, no linkage.
Three stacked springs, linked by anchors located at the “P” points, illustrated in FIG. 12.

By stacking three springs, a 2.5-fold increase in the resulting stiffness was observed, with no differences in this respect being evidenced by the use or non-use of anchors at the “P” connection points.

Likewise, for the cases of multiple springs, no significant alterations to the offset homogeneity were observed. However, in the case of a single spring, a greater offset disparity was observed, increasing these disparities by 200% with respect to the other variants.

In conclusion, the feasibility of forming multi-spring packings that apply a higher compressive force, compared to the force resulting from the use of a single singular spring, was proven.

Similarly, it was found that the use of anchors between the springs of these packings does not produce any negative impact.

1. A low operating torque pneumatic seed metering unit comprising:
a first housing (30) defining a vacuum chamber and a second housing (40) defining a seed chamber; and that both housings (30; 40), in turn, define two halves of the device;
a feeding nozzle (41) wherein the seeds to be dosed enter the seed chamber (40);
a dosing plate (42) housed in the gap defined inside the housings (30; 40); wherein said dosing plate (42) is comprising a series of alveoli (421), arranged parallel to the perimeter thereof, for housing respectively in each of said alveoli (421), the seeds found inside the seed chamber (40), by the action of a vacuum pressure;
an outlet nozzle (43) wherein the grains are dispensed into the field from the dosing plate (42) in a sequential manner;
a shaft (31) that transmits the rotation from the control to a driving disk (311) on which the dosing plate (42) is coupled, by means of fixing means that allow the joint movement of both;
a rigid seal (32), which delimits a vacuum zone (302) inside the vacuum chamber (30), wherein said seal (32) contacts the dosing plate (42) to ensure the sealing of the vacuum zone (302), and furthermore presents a semi-circular shape comprising a larger perimeter (322), which follows the contour of the housing of the vacuum chamber (30) and completely covers the line of alveoli (421) of the seed plate (42); interrupted by two radial sections (321), which extend inwardly; and a smaller perimeter (323), which connects said radial sections (321) and closes the total contour of said seal (32);
an orthoplane spring (50) which exerts the compression force for the seal (32) to contact the metering plate (42), and comprising an outer contour (51) which imitates and accompanies the silhouette of the rigid seal (32), an inner perimeter (52), linked to the outer contour (51) by means of a plurality of spokes (53) and, a center (54), comprising a central bore (55), wherein the drive shaft (31) passes, a plurality of lever arms (57), which link the center (54) with the inner perimeter (52) and perform the axial effort to press the seal (32) against the metering plate (42), wherein said orthoplane spring (50) further prevents the seal from rotating with respect to the shaft (31).

2. The pneumatic dispenser of claim 1, wherein the plurality of lever arms (57) of the orthoplane spring (50) comprising at least three lever arms (57).

3. The pneumatic dispenser according to claim 1, wherein the lever arms (57) of the orthoplane spring (50) are comprising fork-shaped levers (58).

4. The pneumatic dispenser of claim 3, wherein the lever arms (57) have lever lengths (58) different from each other calibrated to adjust compression as a function of their distance from the outer contour (51) linked to the rigid seal (32).

5. The pneumatic dispenser according to claim 1, wherein the orthoplane spring (50) is made of a single piece.

6. The pneumatic dispenser according to claim 1, wherein the orthoplane spring (50) is made up of a packing of overlapping lamellae.

7. The pneumatic dispenser of claim 5, wherein the overlapping sheets forming the packing are linked together by means of fastening means.

8. The pneumatic dispenser according to claim 1, wherein the orthoplane spring (50) is linked to the rigid seal (32) by means of interlocking; glued; riveted and/or welded inserts.

9. The pneumatic dispenser according to claim 1, wherein the orthoplane spring (50) and the rigid seal (32) form a single part, formed by molding, unit injection, co-injection of various materials, or a combination thereof.

10. The pneumatic dispenser according to claim 1, wherein the central bore (55) of the orthoplane spring (50) comprising at least one notch (56) for engagement with locking means that prevent movement and angular offset of the spring (50) and seal set (32).

11. The pneumatic dispenser according to claim 1, further comprising a subframe (60) comprising a plurality of spokes (61), extending from a center (62) towards an outer contour (63), which mimics and accompanies the silhouette of the rigid seal (32); wherein said center (62) comprises in its upper part, at least one protrusion and/or recess (64) which is the complement of the at least one notch (56) openworked in the central bore (55) of the orthoplane spring (50).

12. The pneumatic dispenser according to claim 11, wherein the outer contour (63) of the subframe (60), has a flange arrangement that holds, against the vacuum chamber housing (30), an elastic membrane (70).

13. The pneumatic dispenser according to claim 12, wherein the elastic membrane (70) has a contour that mimics and accompanies the silhouette of the rigid seal (32), is essentially flat and has a band width such that it protrudes from the outer contour flange (63) of the subframe (60).

14. The pneumatic dispenser according to claim 13, wherein the bonding between the subframe (60) and the elastic membrane (70) may be by gluing, riveting, screwing, screwing, or snapping.

15. The pneumatic dispenser according to claim 1, wherein the orthoplane spring (50) is located in a seat (81) formed directly in the vacuum chamber housing (30).

16. The pneumatic dispenser according to claim 15, wherein the seat (81) is comprising at least one recess (82), which is the complement of the at least one notch (56) shimmed in the central bore (55) of the orthoplane spring (50).

17. The pneumatic dispenser according to claim 16, further comprising a flange (83) supporting the elastic membrane (70).

18. The pneumatic dispenser according to claim 12, wherein the elastic membrane (70) has a geometry other than flat, thus forming a bellows, and may contain on its periphery at least one of the following: a lip, a flange, a raised extension, or a combination thereof.

19. The pneumatic dispenser according to claim 1, wherein the rigid seal (32) may be made of acetal resin, or other polymer of low coefficient of friction and high attrition resistance.

20. The pneumatic dispenser according to claim 1, wherein the rigid seal (32) is compound of a first structural material in its body, such as metal, polymers, acetal resin or plastic, or combinations thereof; and of a second material in the contact area with the plate (42), such as acetal resin or other polymers of low friction coefficient and high attrition resistance.

21. The pneumatic dispenser according to claim 1, wherein the orthoplane spring (50) is formed of a material selected from the group comprising: spring steel, polymers with glass fiber loading, polymers without glass fiber loading, or a combination thereof.

22. The pneumatic dispenser according to claim 12, wherein the elastic membrane (70) is formed of silicone, NBR, or a combination thereof.
